(19) United States
(12) Patent Application Publication
(10) Pub. No.: US 2004/0001931 A1
(43) Pub. Date: Jan. 1, 2004

(54) Linerless printable adhesive tape

(75) Inventors: Guglielmo Memo Izzi, Maplewood, MN (US); Thomas P. Hanschen, St. Paul, MN (US); Zhiming Zhou, Woodbury, MN (US); Albert I. Everaerts, Oakdale, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 10/424,218

(22) Filed: Apr. 25, 2003

Related U.S. Application Data
(60) Provisional application No. 60/391,497, filed on Jun. 25, 2002.

(51) Int. Cl. B32B 9/00

(52) U.S. Cl. 428/40.1; 428/343; 428/172; 428/119

(57) ABSTRACT

The present invention is directed to an article comprising a backing, the backing comprising a first major surface and a second major surface, wherein the first major surface comprises a microstructured surface comprising microstructure elements; and a low-flow adhesive layer opposite the microstructured surface. Additionally, the present invention is directed to multi-layer embodiments that are linerless.

### CROSS REFERENCE TO RELATED APPLICATIONS

This application claims priority to Provisional Application No. 60/391,497, filed Jun. 25, 2002.

### FIELD OF THE INVENTION

The present invention relates to printable adhesive articles.

### BACKGROUND OF THE INVENTION

The present invention is related to printable adhesive articles. The present invention is especially useful for linerless adhesive tapes and labels. Images and printed matter including indicia, bar codes, symbols and graphics are common. Images and data that warn, educate, entertain, advertise or otherwise inform, etc. are applied on a variety of interior and exterior surfaces.

Techniques that may be used to print images and printed matter include thermal mass transfer printing (also known simply as thermal transfer printing), dot-matrix printing, laser printing, electrophotography (including photocopying) and inkjet printing. Inkjet can include printing by drop-on-demand inkjet or continuous inkjet techniques. Drop on demand techniques include piezo inkjet and thermal inkjet printing which differ in how the ink drops are created.

Inkjet inks can be organic-solvent based, aqueous (water-based) or solid (phase-change) inkjet inks. Solid inkjet inks have a solid wax or resin binder component. The ink is melted. The molten ink is then printed by inkjet.

The components of an inkjet system used for making graphics can be grouped into three major categories: the computer, software, and printer category, the ink category and the category of receptor medium.

The computer, software, and printer will control the size, number and placement of the ink drops and will transport the receptor medium through the printer. The ink will contain the colorant. The receptor medium provides a repository to accept and hold the ink. The quality of the inkjet image is a function of the total system.

The composition and interaction between the ink and receptor medium is most important in an inkjet system. With printers now exceeding 2400×2400 dpi resolution, inkjet drop size is smaller than in the past. A typical drop size for this dpi precision, is less than about 10 picoliters. Some printer makers are striving for even smaller drop sizes, while other printer makers are content with the larger drop sizes for large format graphics.

Containers, packages, cartons, and cases, (generally referred to as “boxes”) for storing and shipping products typically use box sealing tape, such as an adhesive tape, to secure the flaps or covers so that the box will not accidentally open during normal shipment, handling, and storage. Box sealing tape maintains the integrity of a box throughout its entire distribution cycle. Box sealing tape can be used on other parts of boxes and on other types of article. A typical box sealing tape comprises a plastic film backing with a printable surface and a pressure-sensitive adhesive layer. This tape can be printed and applied to a box to seal the box. It can also be printed, cut into a label and applied onto a box or article. These tapes can be made in roll or pad form, and can have information printed or otherwise applied to, or contained within or on, the tape.

These boxes generally display information about the contents. This information most commonly located on the box might include lot numbers, date codes, product identification information, and bar codes. The information can be placed onto the box using a number of methods. These include preprinting the box when it is manufactured, or printing this information onto the box at the point of use. Other approaches include the use of labels, typically white paper with preprinted information either applied manually, or with an online automatic label applicator.

A recent trend in conveying information related to the product is the requirement to have the information specific for each box. For example, each box can carry specific information about its contents and the final destination of the product, including lot numbers, serial numbers, and customer order numbers. The information is typically provided on tape or labels that are customized and printed on demand, generally at the point of application onto the box.

One system for printing information involves thermal transfer ink printing onto tape or labels using an ink ribbon and a special heat transfer print head. A computer controls the print head by providing input to the head, which heats discrete locations on the ink ribbon. The ink ribbon directly contacts the label so that when a discrete area is heated, the ink melts and is transferred to the label. Another approach using this system is to use labels that change color when heat is applied (direct thermal labels). In another system, variable information is directly printed onto a box or label by an inkjet printer including a print head. A computer can control the ink pattern sprayed onto the box or label.

Both thermal transfer and inkjet systems produce sharp images. With both inkjet and thermal transfer systems, the print quality depends on the surface on which the ink is applied. It appears that the best system for printing variable information is one in which the ink and the print substrate can be properly matched to produce a repeatable quality image, especially bar codes, that must be read by an electronic scanner with a high degree of reliability.

Regardless of the specific printing technique, the printing apparatus includes a handling system for guiding a continuous web of tape to the print head away from the print head following printing for subsequent placement on the article of interest (for example, a box). To this end, the web of tape is normally provided in a rolled form (“tape supply roll”), such that the printing device includes a support that rotatably maintains the tape supply roll. When the tape roll is linerless, the adhesive of the tape is in intimate contact with the printable surface of the next wrap of tape in the roll.

Examples of microstructured ink receptor media can be found in WO 99/55537, WO 00/73083, WO 00/73082, WO 01/58697 and WO 01/58698.

### SUMMARY OF THE INVENTION

Using a microporous or microstructured ink receptor adhesive article without a liner has created special problems. Generally, the adhesive layer tends to flow into the microstructured elements of the microstructure surface or the porous surface of a microporous substrate. Under certain conditions of time, pressure and temperature, the adhesive layer may become transferred or bonded to the surface below. Therefore, in stacks of linerless labels or in a roll of tape, the adhesive can no longer be separated from the microstructured surface directly below it. This results in either failure between the adhesive and its backing or complete failure to remove the top layer of the adhesive article.

The present invention is directed to an adhesive article having a receptor medium comprising a microstructured surface that can be stacked into a pad or wound into a roll of tape and maintain the removability of the top adhesive article or the leading edge of the tape.

The present invention is directed to an article comprising a backing, the backing comprising a first major surface and a second major surface, wherein the first major surface comprises a microstructured surface comprising microstructure elements; and a low-flow adhesive layer opposite the microstructured surface.

In another aspect of the invention, the present invention discloses an article comprising a backing comprising a first major surface and a second major surface, wherein the first major surface comprises a microstructured surface comprising microstructured elements; and a pressure sensitive adhesive layer on the second major surface of the backing, wherein the pressure sensitive adhesive comprises a pressure sensitive adhesive matrix and a fibrous reinforcing material within the pressure sensitive adhesive matrix.

In another aspect, the present invention discloses an article comprising a backing, the backing comprising a first major surface and a second major surface, wherein the first major surface comprises a microstructured surface comprising microstructured elements; and an adhesive layer opposite the microstructured surface, wherein the peel adhesion is no greater than 9.5 N/cm.

In another aspect, the present invention discloses an article comprising a backing, the backing comprising a first major surface and a second major surface, wherein the first major surface comprises a microstructured surface comprising microstructure elements; and an adhesive layer on the second major surface of the backing, wherein the adhesive has a creep compliance of less than 7×10⁻⁴ Pa⁻¹ and a viscosity greater than 1×10⁶ Pa·s.

The present invention is also directed to multi-layered embodiments of these articles that are linerless.

### BRIEF DESCRIPTION OF THE DRAWINGS

FIG. 1 is an elevated view of a first embodiment of the present invention.

FIG. 2 is an elevated view of a second embodiment of the present invention.

FIG. 3 is a transverse cross-sectional view of the embodiment illustrated in FIG. 1 along line 3-3.

FIG. 4 is a cross-sectional view of an embodiment of the present invention with an adhesive layer including a fibrous reinforcing material.

FIG. 5 is a cross-sectional view of an embodiment of the present invention including a multilayer structure.

### DETAILED DESCRIPTION OF THE INVENTION

For the purpose of the present invention, the following terms shall be defined:

“Microstructured element” means a recognizable geometric shape that either protrudes or is depressed.

“Microstructured surface” is a surface comprising microstructured elements.

“Low flow adhesive” is an adhesive that does not flow into the microstructured elements of a particular microstructured surface more than 10 micrometers after 24 hours at 70° C. as tested according to the Accelerated Adhesive Flow Test defined in the Examples section below.

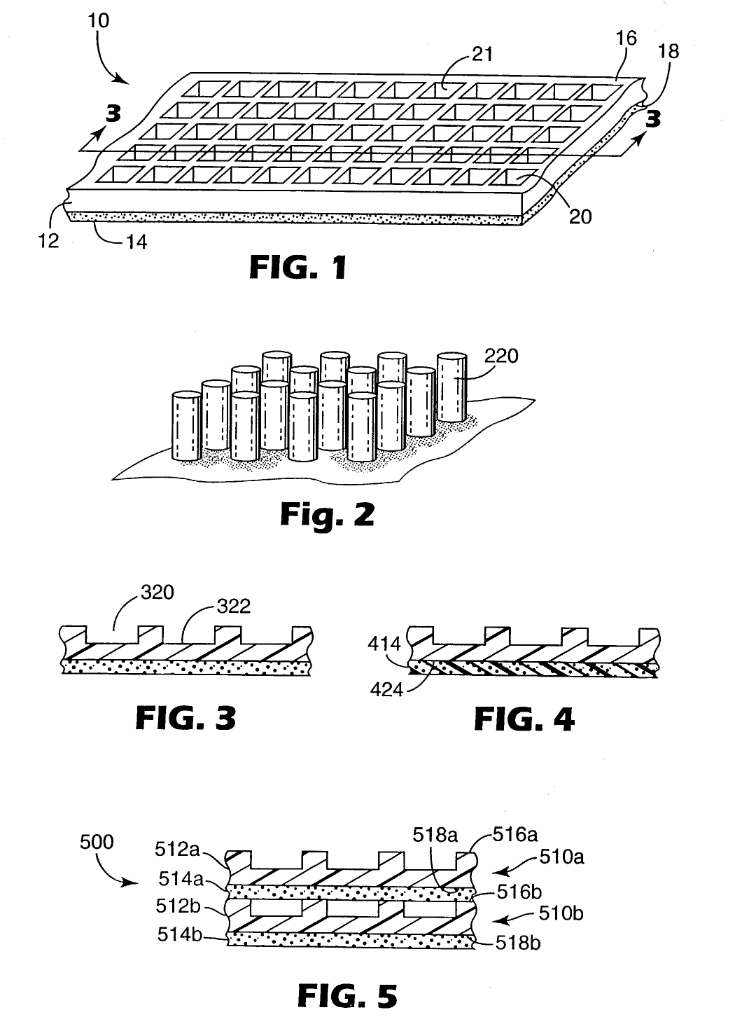

FIG. 1 illustrates an adhesive article embodying features of the invention. The adhesive article 10 comprises a microstructured backing 12 and an adhesive layer 14. The microstructured backing 12 comprises a first major surface 16 and a second major surface 18. In the embodiment illustrated in FIG. 1, the first major surface 16 of the microstructured backing defines microstructured elements, in this case depressed microstructured elements 20, within the first major surface 16. The low flow-adhesive layer is opposite the first major surface. In the embodiment of FIG. 1, the low-flow adhesive layer 14 is in contact with the second major surface 18 of the microstructured backing 12. However, additional layers, such as adhesive layers, may be between the low-flow adhesive and the second major surface (not shown). The adhesive layer 14 may be a continuous layer or a discontinuous layer (e.g. stripes or dots of adhesive.) The microstructured elements 20 are enclosed by walls 21. The walls 21 illustrated in FIG. 1 are of a uniform height. However, in some embodiments, the wall height may be variable. For example, the walls 21 may have a shorter height in the center of the walls than at the intersection point of two walls. Embodiments having variable wall height are disclosed in U.S. Ser. No. 10/183,121, filed Jun. 25, 2002 and incorporated by reference. Generally, the first major surface 16 comprises the microstructured elements. The walls 21 generally have a height of from about 5 to about 200 micrometers, for example between about 5 and about 100 micrometers. The walls of the generally have a thickness of between about 1 to about 50 micrometers, for example between about 1 and about 30 micrometers. In certain examples, the walls have a width of between about 5 and about 30 micrometers.

FIG. 2 illustrates a second embodiment of the present invention wherein the microstructured elements 220 are protruding microstructured elements.

Microstructured element pitch is in the range of from 1 to about 1000 micrometers. Certain embodiments have a microstructured element pitch of from about 10 to about 500 micrometers, for example from about 50 to about 400 micrometers. The microstructured element pitch may be uniform, but it is not always necessary or desirable for the pitch to be uniform. It is recognized that in some embodiments of the invention, it may not be necessary, or desirable, that uniform microstructured element pitch be observed, nor that all features be identical. Thus, an assortment of different types of features, for example, microstructured elements with, perhaps, an assortment of microstructured element pitches may comprise the microstructured surface of the image transfer media according to the invention. The average peak to valley distances of individual elements is from about 1 to about 200 micrometers.

The microstructured elements may have any structure. For example, the structure for the microstructured element can range from the extreme of cubic elements with parallel vertical, planar walls, to the extreme of hemispherical elements, with any possible solid geometrical configuration of walls in between the two extremes. Specific examples include cube elements, cylindrical elements, conical elements with angular, planar walls, truncated pyramid elements with angular, planar walls, honeycomb elements, and cube corner shaped elements. Other useful microstructured elements are described in PCT publications WO 00/73082 and WO 00/73083, incorporated by reference herein.

The pattern of the topography can be regular, random, or a combination of the two. “Regular” means that the pattern is planned and reproducible. “Random” means one or more features of the microstructured elements are varied in a non-regular manner. Examples of features that are varied include for example, microstructured element pitch, peak-to valley distance, depth, height, wall angle, edge radius, and the like. Combination patterns may for example comprise patterns that are random over an area having a minimum radius of ten microstructured element widths from any point, but these random patterns can be reproduced over larger distances within the overall pattern. The terms “Regular”, “Random” and “Combination” are used herein to describe the pattern imparted to the length of web by one repeat distance of the tool having a microstructured pattern thereon. For example, when the tool is a cylindrical roll, one repeat distance corresponds to one revolution of the roll. In another embodiment, the tool may be a plate and the repeat distance would be a plate and the repeat distance would correspond to one or both dimensions of the plate.

The volume of a microstructured element can range from about 1 to about 20,000 pL, for example from about 1 to about 10,000 pL. Certain embodiments have a volume of from about 3 to about 10,000 pL, for example from about 30 to about 10,000 pL, such as from about 300 to about 10,000 pL. The volumes of the microstructured elements may decrease as printing technology leads to smaller ink drop size.

For applications in which desktop inkjet printers (typical drop size of 3-20 pL) will be used to generate the image, microstructured element volumes generally range from about 300 to about 8000 pL. For applications in which large format desktop inkjet printers (typical drop size of 10-200 pL will be used to generate the image, microstructured element volumes range from about 1,000 to about 10,000 pL.

Another way to characterize the structure of the microstructured elements 20 is to describe the microstructured elements in terms of aspect ratios. An “aspect ratio” is the ratio of the depth to the width of a depressed microstructured element or the ratio of height to width of a protruding microstructured element. Useful aspect ratios for a depressed microstructure element range from about 0.01 to about 2, for example from about 0.05 to about 1, and in specific embodiments from about 0.05 to about 0.8. Useful aspect ratios for a protruding microstructure element range from about 0.01 to about 15, for example from about 0.05 to about 10, and in specific embodiments from about 0.05 to about 8.

The overall height of the primary microstructured elements depends on the shape, aspect ratio, and desired volume of the microstructured element. The height of a microstructured element can range from about 5 to about 200 micrometers. In some embodiments, the height ranges from about 20 to about 100 micrometers, for example about 30 to about 90 micrometers.

Microstructured element pitch is in the range of from 1 to about 1000 micrometers. Certain embodiments have a microstructured element pitch of from about 10 to about 500 micrometers, for example from about 50 to about 400 micrometers. The microstructured element pitch may be uniform, but it is not always necessary or desirable for the pitch to be uniform. It is recognized that in some embodiments of the invention, it may not be necessary, or desirable, that uniform element pitch be observed between microstructured elements, nor that all features be identical. Thus, an assortment of different types of features, for example, microstructured elements with, perhaps, an assortment of pitches may comprise the microstructured surface. The average peak to valley distances of individual elements is from about 1 to about 200 micrometers.

FIG. 3 shows a longitudinal cross sectional view of the embodiment illustrated in FIG. 1 along the line 3-3. The microstructured elements 320 have a surface 322. The microstructured element surface 322 may be smooth or textured (e.g. additional minor microstructured elements within the major microstructured element surface 322 (not shown)) as shown in U.S. Ser. No. 10/183,122, Filed Jun. 25, 2002 and incorporated by reference. The minor microstructured elements may have any pattern, such as straight lines or cross-cut lines. FIG. 4 illustrates another embodiment of the invention in a longitudinal cross sectional view. In FIG. 4, the adhesive layer 414 comprises fibrous reinforcement 424.

FIG. 5 shows an embodiment of the present invention in a multilayer structure 500. FIG. 5 illustrates two layers of a multilayer structure with first adhesive article 510a and second adhesive article 510b. The first adhesive article 510a comprises a microstructured backing 512a and an adhesive layer 514a. The microstructured backing 512a comprises a first major surface 516a and a second major surface 518a. The second adhesive article 510b comprises a microstructured backing 512b and an adhesive layer 514b. The microstructured backing 512b comprises a first major surface 516b and a second major surface 518b. The first adhesive layer 514a is in direct contact with the first major surface of 516b of the second microstructured backing 512b. Therefore, in order to remove the first adhesive article 510a from the second adhesive article 510b, the first adhesive layer 514a releases from the first major surface of 516b of the second microstructured backing 512b.

Microstructured Backing

The microstructured backing typically comprises a polymer. The backing can be a solid film. The backing can be transparent, translucent, or opaque, depending on desired usage. The backing can be clear or tinted, depending on desired usage. The backing can be optically transmissive, optically reflective, or optically retroreflective, depending on desired usage.

Nonlimiting examples of polymeric films useful as backing in the present invention include thermoplastics such as polyolefins (e.g. polypropylene, polyethylene), poly(vinyl chloride), copolymers of olefins (e.g. copolymers of propylene), copolymers of ethylene with vinyl acetate or vinyl alcohol, fluorinated thermoplastics such as copolymers and terpolymers of hexafluoropropylene and surface modified versions thereof, poly(ethylene terephthalate) and copolymers thereof, polyurethanes, polyimides, acrylics, and filled versions of the above using fillers such as silicates, silica, aluminates, feldspar, talc, calcium carbonate, titanium dioxide, and the like. Also useful in the application are coextruded films and laminated films made from the materials listed above. More specifically, the microstructured backing is formed from polyvinyl chloride, polyethylene, polypropylene, and copolymers thereof.

It is advantageous that the whole depth of the microstructured layer be made of a transparent material such as the Fina 3376 polypropylene exemplified. This is so that after printing, any colored materials that are resident in the microstructured elements or crevices of the microstructure are clearly visible. This gives the best color saturation and optical density in printed images. If it is desired to have a white microstructured film, whiteness is preferentially obtained either by using a white adhesive or by having a transparent microstructured layer on a white film as exemplified herein.

Properties of the backing used in the present invention can be augmented with optional coatings that improve control of the ink receptivity of the microstructured surface of the backing. Any number of coatings are known to those skilled in the art. It is possible to employ any of these coatings in combination with the microstructured surface of the present invention.

One can employ a fluid management system having a variety of surfactants or polymers can be chosen to provide particularly suitable surfaces for the particular fluid components of the pigmented inkjet inks. Surfactants can be cationic, anionic, nonionic, or zwitterionic. Many types of surfactant are widely available to one skilled in the art. Accordingly, any surfactant or combination of surfactants or polymer(s) that will render a polymer surface hydrophilic can be employed.

These surfactants can be coated or otherwise applied onto the microstructured element surface of the microstructured elements in the microstructured surface. Various types of surfactants have been used in the coating systems. These may include but are not limited to fluorochemical, silicon and hydrocarbon-based ones wherein the said surfactants may be cationic, anionic or nonionic. Furthermore, the nonionic surfactant may be used either as it is or in combination with another surfactant, such as an anionic surfactant in an organic solvent or in a mixture of water and organic solvent, the said organic solvents being selected from the group of alcohol, amide, ketone and the like.

Various types of non-ionic surfactants can be used, including but not limited to: fluorocarbons, block copolymers of ethylene and propylene oxide to an ethylene glycol base, polyoxyethylene sorbitan fatty acid esters, octylphenoxy polyethoxy ethanol, tetramethyl decynediol, silicon surfactants and the like known to those skilled in the art.

A release coating (low adhesion backsize) may additionally be applied to the microstructured surface. The release coating may be a continuous layer or a discontinuous layer (e.g., stripes and dots.) The release coating may be applied to the entire microstructured surface, including the microstructured elements, or only to certain areas of the microstructured surface. For example, in embodiments comprising depressed microstructured elements, the release coating may be applied only to the surface and not within the microstructured elements. In some embodiments, a release material can be blended with the material used to make the microstructured backing and incorporated into the backing.

Other coating materials may be used which are intended to improve the appearance or durability of the printed image on the microstructured surface. For example, an inkjet receptor coating may be used. The inkjet receptor coating may comprise one or more layers. Useful ink receptive coatings are hydrophilic and aqueous ink sorptive. Such coatings include, but are not limited to, polyvinyl pyrrolidone, homopolymers and copolymers and substituted derivatives thereof, polyethyleneimine and derivatives, vinyl acetate copolymers, for example, copolymers of vinyl pyrrolidone and vinyl acetate, copolymers of vinyl acetate and acrylic acid, and the like, and hydrolyzed derivatives thereof; polyvinyl alcohol, acrylic acid homopolymers and copolymers; co-polyesters; acrylamide homopolymers and copolymers; cellulosic polymers; styrene copolymers with allyl alcohol, acrylic acid, and/or maleic acid or esters thereof, alkylene oxide polymers and copolymers; gelatins and modified gelatins; polysaccharides, and the like. If the targeted printer prints aqueous dye inks, then a suitable mordant may be coated onto the microstructured surface in order to demobilize or “fix” the dyes. Mordants that may be used generally consist of, but are not limited to, those found in patents such as U.S. Pat. No. 4,500,631; U.S. Pat. No. 5,342,688; U.S. Pat. No. 5,354,813; U.S. Pat. No. 5,589,269; and U.S. Pat. No. 5,712,027. One specific example of an inkjet receptor coating is a solution containing polyvinyl pyridine and copolymers thereof as described in copending U.S. Ser. No. 10/361,414, filed Feb. 11, 2003 and incorporated herein by reference. Various blends of these materials with other coating materials, for example a blend of a release agent and an inkjet receptor, listed herein are also within the scope of the invention.

Additionally, directly affecting the substrate by means generally known in the art may be employed in the context of this invention. For example, flame treated surfaces, corona treated surfaces (e.g. air or nitrogen), or surface dehydrochlorinated poly(vinyl chloride) could be made into a microstructured backing as a printable substrate.

Adhesive

The adhesive of the present invention is an adhesive having a minimum of flow into the microstructured elements. The adhesive may be, for example a heat activatable adhesive, or a suitable pressure sensitive adhesive. Some suitable adhesives may be pressure sensitive adhesives. Suitable pressure sensitive adhesive components can be any material that has pressure sensitive adhesive properties including the following: (1) permanent tack at room temperature (20° C. to 25° C.), (2) adherence to a substrate with no more than finger pressure, (3) sufficient ability to hold onto an adherend, and (4) sufficient cohesive strength to be removed from the adherend. Furthermore, the pressure sensitive adhesive component can be a single pressure sensitive adhesive or the pressure sensitive adhesive can be a combination of two or more pressure sensitive adhesives.

Pressure sensitive adhesives useful in the present invention include, for example, those based on natural rubbers, synthetic rubbers, styrene block copolymers, polyvinyl ethers, poly (meth)acrylates (including both acrylates and methacrylates), polyolefins, and silicones.

The pressure sensitive adhesive base material may be inherently tacky. If desired, tackifiers may be added to the base material to form the pressure sensitive adhesive. Useful tackifiers include, for example, rosin ester resins, aromatic hydrocarbon resins, aliphatic hydrocarbon resins, and terpene resins. Other materials can be added for special purposes, including, for example, oils, plasticizers, antioxidants, ultraviolet (“UV”) stabilizers, hydrogenated butyl rubber, pigments, and curing agents.

In a specific embodiment, the pressure sensitive adhesive is based on styrene-isoprene-styrene block copolymer.

In certain embodiments, the adhesive is a heat activatable adhesive. Such adhesives have the characteristic that they are non-tacky until a certain activation temperature is reached. Once the activation temperature has been reached, the adhesive becomes tacky and bondable. Certain embodiments of heat activatable adhesives include adhesives comprising waxes. Certain adhesive compositions may be formulated into heat activatable adhesives if blended or coated with a wax. Examples of such heat activatable adhesives are those described in U.S. Pat. No. 5,569,515 (Rice et al); U.S. Pat. No. 4,942,195 (Flanagan et al); U.S. Pat. No. 6,034,159 (Malcolm); and U.S. Pat. No. 5,275,589 (Bozich), incorporated by reference. Specific examples of waxes include polyethylene waxes, such as those sold under the tradename POLYWAX, available from Baker-Petrolite, Sugar Land, Tex. Additional heat activatable adhesives include adhesives with a main or a side chain crystallinity, such as those described in U.S. Pat. No. 5,156,911 (Stewart) and U.S. Pat. No. 5,387,450 (Stewart), incorporated by reference. Another example of a heat activatable adhesive are compositions originally formulated as pressure sensitive adhesive which have been over tackified, such as those described in U.S. Pat. No. 4,248,748 (McGrath), incorporated by reference.

In some embodiments, the adhesive is a low-flow adhesive. A low-flow adhesive is defined, for the purpose of the present application, as an adhesive that does not flow into the microstructured elements of a particular microstructured surface more than 10 micrometers after 24 hours at 70° C. as tested according to the Accelerated Adhesive Flow Test defined in the Examples section below. Generally, a low flow adhesive will not flow more than 8 micrometers after 24 hours at 70° C. as tested according to the Accelerated Adhesive Flow Test. Flow of an adhesive is the natural movement of a fluid adhesive as opposed to propagation of a crack.

In some embodiments, the adhesive has a creep compliance of less than 7×10⁻⁴ Pa⁻¹. In other embodiments the adhesive has a creep compliance of less than 5×10⁻⁴ Pa⁻¹, for example less than 3×10⁻⁴ Pa⁻¹ and in further example less than 2×10⁻⁴ Pa¹. Such an adhesive may additionally have a viscosity greater than 1×10⁶ Pa·s, for example greater than 5×10⁶ Pa·s and in further example greater than 1×10⁷ Pa·s. In embodiments where the adhesive is a heat activatable adhesive, the compliance is low and the viscosity is high below the activation temperature. However, above the activation temperature, the compliance may increase and the viscosity may decrease outside the ranges discussed above.

In some embodiments of the invention, the adhesive is a fiber reinforced pressure sensitive adhesive as described in co-pending U.S. application U.S. Ser. No. 09/764,478, filed Jan. 17, 2001 and the continuation in part U.S. Ser. No. 10/180,784, Filed Jun. 25, 2002, which are incorporated herein by reference. In such an embodiment, any suitable pressure sensitive adhesive composition can be used as a matrix of adhesive for the fiber reinforced adhesive. The pressure sensitive adhesive may be a low-flow adhesive or a low creep adhesive, though any pressure sensitive adhesive may still be adequate as a matrix for the fiber reinforced pressure sensitive adhesive. In certain embodiments, the pressure sensitive adhesive matrix has an inherent viscosity of at least about 0.45dl/g. The inherent viscosity is measured on a solution of the adhesive in a solvent at 25° C. The difference in out-flow time between the polymer solution and solvent is measured using a Schott Gerate capillary viscometer to find the relative viscosity. For example, for acrylic adhesives, the solvent is ethyl acetate and the polymer is at a concentration of 0.1 g/dL. The inherent viscosity is then calculated as the natural log of the relative viscosity over the concentration.

The pressure sensitive adhesive is then reinforced with a fibrous reinforcing material. Various reinforcing materials may be used to practice the present invention, including glass fibers and woven or non-woven fabrics. In specific embodiments, the reinforcing material is a polymer. In certain embodiments, the reinforcing material is elastomeric. Examples of the reinforcing material include an olefin polymer, such as ultra low density polyethylene. In certain embodiments, for example embodiments with lower flow, the pressure sensitive adhesive matrix has an inherent viscosity of at least about 0.45dl/g. The inherent viscosity is measured by dissolving the adhesive in a solvent at 25° C. The out-flow time is then measured using s Schott Cerate capillary viscometer to find the relative viscosity. For example, for acrylic adhesives, the solvent is ethyl acetate at a concentration of 0.1 g/dL. The inherent viscosity is then calculates as the natural log of the relative viscosity over the concentration.

It is particularly desirable for the reinforcing material to have a melt viscosity similar to the melt viscosity of the pressure sensitive adhesive at the processing temperature of the method of this invention. In specific embodiments, the ratio of the reinforcing material melt viscosity to the pressure sensitive adhesive melt viscosity at the processing temperature is less than about 3, preferably less than about 1.5. For example, the ratio is between about 0.5 and about 1.2 depending on specific extrusion parameters (e.g., screw design, shear rate, screw speed, temperature). Melt viscosity is measurable as understood by one skilled in the art using a capillary viscometer.

The reinforcing material may be immiscible (i.e. remains in a separate phase) in the pressure sensitive adhesive during mixing so that the reinforcing material can be substantially uniformly dispersed (i.e. distributed) in the pressure sensitive adhesive. In specific embodiments, during mixing, the reinforcing material is in the form of substantially spherical particles having an average diameter less than about 20 micrometers. In certain embodiments, the reinforcing material has an average diameter less than about 10 micrometers.

In addition to the previously described materials other useful materials include polyethylene (e.g., high density polyethylene from Equistar Chemicals, Houston Tex. as well as medium-low density polyethylenes and low density polyethylenes); polypropylene copolymers; polymethyl methacrylate; thermoplastic polyurethane (TPU form Dow Chemical or BF Goodrich); polystyrene; polyvinyl acetate; polyvinyl chloride; polyoxymethylene; poly (ethylene-co-acrylic acid); poly (ethylene-co-methacrylic acid); poly (styrene-co-allyl alcohol); polyamides; polyether-co-polyamide block copolymers such as PEBAX (from Atofina Chemicals, Philadelphia, Pa.); polyesters such as TONE polymers P-767 and P-787 (from Union Carbide, Danbury, Conn.); block copolyester elastomers such as HYTREL (from DuPont, Wilmington, Del.); and mixtures thereof. Preferred materials are ATTANE 4202 (available from Dow Chemical) and EXACT 3040 (available from ExxonMobile Corp.).

In a specific embodiment, the reinforcing material exists as substantially continuous fibers in the adhesive composition. Specifically, according to one aspect of the invention, the fibers are unbroken for at least about 0.5 centimeters in the machine direction of the pressure sensitive adhesive matrix, for example at least about 2 centimeters. In some embodiments, the substantially continuous fibers are continuous for at least about 5 centimeters and in desirable embodiments the fibers are continuous for at least about 8 centimeters. According to another aspect of the invention, the substantially continuous fibers generally have a maximum diameter of about 0.05 to about 5 micrometers, preferably from about 0.1 to about 1 micrometers. According to another aspect of the invention, the aspect ratio (i.e. the ratio of the length to the diameter) of the substantially continuous fibers is greater than about 1000.

In certain embodiments, the reinforcing material is mixed with the pressure sensitive adhesive before subjecting the mixture to an elongating shear force. Mixing of the reinforcing material and the pressure sensitive adhesive is done by any method that results in a dispersion, preferably a substantially uniform dispersion, of the reinforcing material in the pressure sensitive adhesive. For example, melt blending, solvent blending, or any suitable physical means are able to adequately mix the reinforcing material and the pressure sensitive adhesive.

Melt blending devices include those that provide dispersive mixing, distributive mixing, or a combination of dispersive and distributive mixing. Both batch and continuous methods of melt blending can be used. Examples of batch methods include those using a BRABENDER (e.g. a BRABENDER PREP CENTER, commercially available from C. W. Brabender Instruments, Inc.; South Hackensack, N.J.) or BANBURY internal mixing and roll milling equipment (e.g. equipment available from Farrel Co.; Ansonia, Conn.). After batch mixing, the mixture created may be immediately quenched and stored below melting temperature of the mixture for later processing.

Examples of continuous methods include single screw extruding, twin screw extruding, disk extruding, reciprocating single screw extruding, and pin barrel single screw extruding. The continuous methods can include utilizing both distributive elements, such as cavity transfer mixers (e.g. CTM, commercially available from RAPRA Technology, Ltd.; Shrewsbury, England) and pin mixing elements, static mixing elements or dispersive mixing elements (commercially available from e.g., MADDOCK mixing elements or SAXTON mixing elements as described in “Mixing in Single-Screw Extruders,” Mixing in Polymer Processing, edited by Chris Rauwendaal (Marcel Dekker Inc.: New York (1991), pp. 129, 176-177, and 185-186).

In certain embodiments, the reinforcing material comprises between about 2 and about 70 weight percent of the mixture with the pressure sensitive adhesive. In specific embodiments, the reinforcing material comprises between about 5 and about 60 weight percent of the mixture. For example, the reinforcing material may comprise between about 5 and about 50 weight percent of the mixture. Typically, the pressure sensitive adhesive component comprises between about 30 and about 98 weight percent, preferably between about 40 and about 95 weight percent and more preferably between about 50 and about 95 weight percent of the total mixture. Other additives may also be mixed into the pressure sensitive adhesive composition prior to application thereof, depending on the desired properties of the applied adhesive.

The adhesive composition is subjected to an elongating shear force, creating fibers from the reinforcing material in a pressure sensitive adhesive matrix. Generally, the adhesive composition is formed by continuous forming methods, including hot melt coating, drawing or extruding, the adhesive composition from the elongating shear force device (e.g. a draw die, a film die, or a rotary rod die) and subsequently contacting the drawn adhesive composition to a moving web (e.g. plastic) or other suitable substrate. A related continuous forming method involves extruding the adhesive composition and a co-extruded backing material from a film die and cooling the layered product to form an adhesive tape. Other continuous forming methods involve directly contacting the adhesive composition to a rapidly moving web or other suitable preformed substrate. Using this method, the adhesive composition is applied to the moving preformed web using a die having flexible die lips, such as a rotary rod die.

After forming by any of these continuous methods, the fibers, thus formed, can be solidified by lowering the temperature of the adhesive composition to below the melting point of the reinforcing material. For example, the temperature may be lowered by quenching the adhesive composition using either direct methods (e.g., chill rolls or water baths) or indirect methods (e.g., air or gas impingement). The resulting fiber reinforced adhesive composition is then cooled to ambient temperature. Additional layers of adhesive may be included on the adhesive layer opposite the microstructured backing. For example, a second adhesive layer may be coated on the low flow adhesive layer. The second adhesive layer may or may not be a low flow adhesive. For example, a second adhesive layer that is not a low flow adhesive may be beneficial in a thin layer to maximize the tack of the adhesive article. In another example, a first adhesive layer on the second major surface of the microstructured backing is not a low-flow adhesive, and a second adhesive layer, a low flow adhesive, is on the first adhesive layer opposite the microstructured backing.

Method of Manufacturing the Tape

The tape comprises a microstructured film and an adhesive layer. The microstructured film has a first major surface comprising a microstructured surface and a second major surface. The microstructured surface can be made in a number of ways, such as using casting, coating, or compressing techniques. For example, microstructuring the first major surface of the backing can be achieved by at least any of (1) casting a molten thermoplastic using a microstructured tool having a pattern, (2) coating of a fluid onto a microstructured tool having a pattern, solidifying the fluid, and removing the resulting film, or (3) passing a thermoplastic film through a nip roll to compress against a tool having a microstructured pattern. The tool can be formed using any of a number of techniques microstructured element known to those skilled in the art, selected depending in part upon the tool material and features of the desired topography. Illustrative techniques include etching (for example, via chemical etching, mechanical etching, or other ablative means such as laser ablation or reactive ion etching, etc.), photolithography, stereolithography, micromachining, knurling (for example, cutting knurling or acid enhanced knurling), scoring or cutting, etc. Alternative methods of forming the microstructured surface include thermoplastic extrusion, curable fluid coating methods, and embossing thermoplastic layers which can also be cured.

The compressing method uses a hot press familiar to those skilled in the art of compression molding. The pressure exerted in the press typically ranges from about 48 kPa to about 2400 kPa. The temperature of the press at the mold surface typically ranges from about 100° C. to about 200° C., for example from about 110° C. to about 170° C.

The duration time in the press typically ranges from about one minute to about 5 minutes. The pressure, temperature and duration time used depend primarily on the particular material being microstructured, and the type of microstructured element being generated as is known to those skilled in the art.

The process conditions should be sufficient to cause the material to flow and generally take the shape of the surface of the tool being used. Any generally available commercial hot press may be used.

The extrusion method involves passing an extruded material or preformed substrate through a nip created by a chilled roll and a casting roll engraved with an inverse pattern of the desired microstructure. Or, an input film is fed into an extrusion coater or extruder. A polymeric layer is hot-melt coated (extruded) onto the input film. The polymeric layer is then formed into a microstructured surface.

Single screw or twin screw extruders can be used. Conditions are chosen to meet the general requirements understood to one skilled in the art. For example, the temperature profile in the extruder can range from 100° C. to 250° C. depending on the melt characteristics of the resin. The temperature at the die ranges from 150° C. to 230° C. depending on the melt characteristics of the resin. The pressure exerted in the nip can range from about 140 to about 1380 kPa and preferably from about 350 to about 550 kPa. The temperature of the nip roll can range from about 5° C. to about 150° C., for example from about 10° C. to about 100° C., and the temperature of the cast roll can range from about 25° C. to about 100° C., for example about 40° C. to about 60° C. The speed of movement through the nip typically ranges from about 0.25 to about 10 m/min, but generally will move as fast as conditions allow.

Calendering may be accomplished in a continuous process using a nip, as is known in the film handling arts. In the present invention, a web having a suitable surface, and having sufficient thickness to receive the desired microstructure pattern is passed through a nip formed by two cylindrical rolls, one of which has an inverse image to the desired structure engraved into its surface. The surface layer contacts the engraved roll at the nip. The web is generally heated to temperatures of from 100° C. up to 540° C. with, for example, radiant heat sources (for example, heat lamps, infrared heaters, etc.) and/or by use of heated rolls at the nip. A combination of heat and pressure at the nip (typically, 100 to 500 lb/inch (1.8 kg/centimeter to 9 kg/centimeter)) is generally used in the practice of the present invention.

The second major surface of the microstructured backing is adhesive coated with an adhesive composition as described above. This may be accomplished using any coating technique known in the art.

The resulting adhesive article may include a release liner on the adhesive layer (not shown), though a release liner is not necessary. Release liners are known and commercially available from a number of sources. Examples of release liners include silicone coated kraft paper, silicone coated polyethylene coated paper, silicone coated or non-coated polymeric materials such as polyethylene or polypropylene. The aforementioned base materials may also be coated with polymeric release agents such as silicone urea, fluorinated polymers, urethanes, and long chain alkyl acrylates.

Printed Article

The adhesive article described is desirable to print. The microstructured elements contain any ink receptive coating and any ink applied to the microstructured surface, resulting in a controlled image.

Method of Printing

The adhesive article may be printed by any method known in the art. Specifically, the present adhesive article may be placed into an ink-jet printer and printed at high speeds (i.e., speeds in excess of 5 cm/second) while maintaining a clean image.

### EXAMPLES

Test Methods

Peel Adhesion Strength (Self-Mated)

Two pieces of adhesive tape having a backing with a microstructured outer surface (i.e., the surface opposite that in contact with the adhesive layer) were provided which had a width of one inch (2.54 cm) and a length of approximately 5 inches (12.7 cm). The first piece of the adhesive tape was applied to the second piece of tape such that the adhesive side of the first piece contacted the microstructured side of the second piece to give a layered construction (similar to two wraps of the tape in a roll). This layered construction was placed in a heated press under a pressure of 170 kiloPascals (kPa) (25 pounds per square inch) and a temperature of approximately 50° C. (120° F.) for about three days.

After about 72 hours the press was opened and allowed to cool, after which the aged sample was removed and conditioned for 24 hours at about 73° F. (23° C.) and about 50% relative humidity prior to testing. The sample was evaluated at room temperature for 90° angle peel adhesion strength using a SINTECH 6 (available from MTS Systems Corporation, Research Triangle Park, N.C.) at a separation rate of 50 inches/minute (127 centimeters/minute). The peel strength was recorded. One or two samples were tested.

Peel Adhesion Strength to Steel

The 180 degree angle peel adhesion strength of adhesive tape having a backing with a microstructured outer surface (i.e., the surface opposite that in contact with the adhesive layer) was evaluated according to the test method ASTM D3330. The test was run on unaged single pieces. The peel strength was recorded. Three samples were tested, and the range and average were reported.

Overlap Shear Adhesion Strength to Fiberboard

The shear adhesion strength of adhesive tape having a backing with a microstructured outer surface (i.e., the surface opposite that in contact with the adhesive layer) was evaluated according to the test method ASTM D3654, Method B. The test was run on unaged samples. The shear strength (in minutes to failure) and failure mode were recorded. A “Pop-off” failure mode indicates that the adhesive tape failed by coming cleanly off the fiberboard substrate without leaving adhesive residue. Three samples were tested, and the average failure time and failure mode were reported.

Rolling Ball Tack

The surface tack of adhesive tape having a backing with a microstructured outer surface (i.e., the surface opposite that in contact with the adhesive layer) was evaluated using a rolling ball tack test. The test was run on unaged samples. A piece of the tape having a length of about 12 inches (305 mm) and a width of about 1 inch (25 mm) was attached, with its adhesive surface exposed, to a flat surface at the bottom of an incline. The incline had an angle of 21.3 degrees and a length of 6.5 inches (16.5 cm). A stainless steel ball bearing having a diameter of 7/16 inches (1.1 cm), which had been previously cleaned with diacetone alcohol (1 time) followed by heptane (3 times), was allowed to roll down the incline and onto the tape. The distance the ball bearing traveled along the adhesive surface of the tape until it came to rest was measured. Three tape samples were tested and the average distance was reported.

Activation Temperature

The activation temperature was determined by placing a sample of the adhesive-coated backing on a piece of copy paper (commercially available under the tradename HAMMERMILL COPY PLUS, 20 lb weight, available from International Paper, Memphis, Tenn.) with the adhesive side in contact with the copy paper, and heating the resulting article to various temperatures in a convection oven. The temperature was determined using a thermocouple positioned inside the oven just above the shelf having the article thereon. After equilibration at each temperature, a 4.5 pound (2.04 kg) rubber roller was passed back and forth by hand over the tape one time to ensure intimate contact between the adhesive layer and the paper after which the construction was allowed to cool to room temperature. Once the article was at room temperature, the adhesive-coated backing was peeled back by hand. The activation temperature was defined as the minimum temperature required to form a bond to the paper. Therefore, after cooling, the bond results in the paper being torn when peeled back. If the activation temperature was not reached, the adhesive did not tear the paper after cooling. At lower temperatures, the paper did not stick to the adhesive and the two could be separated cleanly without any damage to the paper.

Accelerated Flow Test

Adhesive tapes having a film or paper backing and an adhesive layer on one side thereof were evaluated for flow into a microstructured surface on a second backing. A sample of the tape, having an adhesive thickness of at least about 24 micrometers and measuring 4.3 inches wide by 8.3 inches long (11 cm by 21 cm), was applied to a film backing of the same dimensions and having a microstructured surface on one side such that the adhesive layer of the tape contacted the microstructured surface of the second film backing. This microstructured film backing was prepared as described in Examples 1-6. A 4.5 pound (2.04 kg) rubber roller was passed back and forth by hand over the tape three times in each direction to ensure intimate contact between the adhesive layer and microstructured surface. The resulting article was placed between two pieces of release liner measuring 8.5 inches wide by 11 inches long (21.5 cm by 28 cm). This construction was then placed between two glass plates that were slightly larger in dimension than the release paper and which had a thickness of about 0.18 inches (4.5 mm). This assembly was placed in an oven at 158° F. (70° C.) with a 2.2 pound (1.0 kilogram) weight positioned on top the assembly. After various dwell times a sample was removed and allowed to cool to room temperature. The cooled samples were then carefully peeled apart by hand to expose the adhesive surface of the tape which exhibited a pattern that was the inverse of that on the microstructured surface of the second backing. The adhesive surface was examined using an optical microscope (Leica DMLM Optical Microsystems, available from Leica Microsystems of Deerfield, Ill.). The microscope was focused on the bottoms of the microstructured grooves in the adhesive layer and the focus adjustment height was read. Without altering the sample position in any way, the microscope was refocused on the square plateau regions of adhesive between the grooves. The focus adjustment height was read again, and the difference calculated. This difference is the distance the adhesive flowed into the microstructure. The greater this distance, the higher the flow of the adhesive. Conversely, the lower this distance, the lower the flow of the adhesive.

Steady State Shear Creep

The creep compliance and low deformation rate viscosity characteristics of various adhesives were evaluated. More specifically, the adhesive material was subjected to a constant load (stress). The resulting deformation (strain) was measured as a function of time. The shear creep test was run on a Universal Stress Rheometer (Model SR5, available from Rheometric Scientific, Piscataway, N.J.). Test samples of the adhesive were prepared by coating the material onto a release liner, drying it, and folding the resulting adhesive film back on itself to create a thin adhesive slab having a thickness of about 0.039 to 0.079 inches (1 to 2 mm). A 1 inch (25 mm) diameter sample of the adhesive was cut from the slab and mounted between the parallel plates of the rheometer. The creep test was performed at a constant temperature of 158° F. (70° C.) with a constant stress of 10,000 Pascals applied to the sample for a time of 1300 seconds. After 1300 seconds, the constant stress was removed and the decay in strain was measured. The steady state compliance (Jo) and the low deformation rate viscosity (ηₒ) were calculated from the results as follows.

The strain (γ) was measured as a function of time and the compliance (J) calculated therefrom using Equation 1:

J(t)=γ(t)/σ (1)

where J is compliance, γ strain, t is time and γ is stress.

The steady state compliance (Jₒ) and low deformation rate viscosity (η₀) were calculated from a plot of compliance versus time using Equation 2:

J(t)=(1/θ₀)t+J₀ (2)

where J is compliance, t is time, (1/θ₀) represents the slopeline in the steady state region of the compliance curve, and J₀ is compliance at time zero as determined by the y intercept of the slopeline.

The Examples are intended to be illustrative only and are not intended to limit the scope of the invention or to be limiting on the scope of the appended claims. All parts, percentages, ratios, etc. in the Examples and the rest of the specification are by weight unless indicated otherwise.

### Examples 1-6

Microstructured Backing Preparation

A microstructured backing film was prepared by extruding a polymer melt resin onto a pigmented liner film. More specifically, a clear polypropylene resin (FINA 3376, a polypropylene homopolymer resin containing calcium stearate and having a melt flow rate of between about 2.5 and about 3.1 g/10 minutes (230° C./2.16 kg load), a Hunter Color “b” of 2.0 or less, and xylene solubles of between about 3.5 and about 4.5%, obtained from ATOFINA Petrochemical Company, Dallas, Tex.) was extruded onto a white polypropylene film having a thickness of approximately 50 micrometers (0.002 inches) (available as BW9 from Nan Ya Plastics Corporation, America; Livingston, N.J.). The extruder was a Killion single screw extruder (available from Davis Standard Killion, Pawcatuck, Conn.). The extruder had a diameter of 3.18 centimeters (cm) (1.25 inches), and five heated zones which were set as follows: Zone 1, 124° C. (255° F.); Zone 2, 177° C. (350° F.); Zone 3, 235° C. (455° F.); Zone 4, 243° C. (470° F.); and Zone 5, 249° C. (480° F.). The die temperature was set at 249° C. (480° F.).

The white colored polypropylene film having extruded resin thereon was passed between two heated nip rollers which were closed under pressure and located in close proximity to the die. The white colored film was wrapped approximately 180° around the upper (rubber) roll and then passed into the nip with the clear extruded polypropylene melt thereon. The upper nip roll was a rubber coated roll and the lower nip roll was a metal tool roll having a microstructured pattern engraved on its surface. The nip rolls both had a diameter of approximately 30.5 cm (12 inches) and were hollow to permit heating or chilling of the rolls by passing a fluid through their interiors. The setpoint of the upper roll was 38° C. (100° F.) and the setpoint of the lower roll was 110° C. (230° F.). The web speed was between about 3.0 and about 3.7 meters/minute (9.8 to 12.1 feet/minute).

The metal tool roll was engraved with two sets of parallel grooves, which were perpendicular to each other. These two perpendicular sets of helical grooves ran at an angle of approximately 45° to the roll axis, and had a depth of approximately 50 micrometers (microns, or μm), a width of approximately 18 μm at the bottom and 31 μm at the top, and were spaced approximately 125 μm apart.

The microstructured surface of the tool roll imparted its pattern into the extruded clear polypropylene resin to provide a two layer polypropylene film backing having a clear first major surface with a microstructured pattern thereon, and a white colored second major surface. The patterned film cooled prior to reaching a windup roll. The pattern on the film comprised wells or recesses formed by walls. The recesses were rhomboidal in shape with a nominal depth of 50 μm, and the walls lay at 45° to the machine direction (web direction) of the microstructured film. The resulting microstructured film backing had a total thickness of 0.0075 inches (190 micrometers). Of this, about 0.002 inches (50 micrometers) is derived from the white colored film and about 0.0055 inches (140 micrometers) is derived from the extruded clear polypropylene layer.

Preparation of Adhesive Tapes Having a Microstructured Backing

Adhesive compositions were coated onto the surface of a microstructured backing opposite that having the microstructured pattern to provide adhesive tapes. More specifically, various adhesive compositions were extrusion coated onto the white colored second major surface of a microstructured backing film, prepared as described above, using a co-rotating twin screw extruder (Werner & Pfleiderer ZSK-30, available from Werner & Pfleiderer, Inc.; Ramsey, N.J.) having a diameter of about 1.18 inches (30 mm) 14 heated zones. The zone and die temperatures were set as follows: Zones 1-4: 280° F. (138° C.); Zones 5-9: 300° F. (149° C.); Zones 10-14: 320° F. (160° C.); Die: 310° F. (154° C.). The web speed was between about 10 to about 12 feet/minute (about 3.0 to about 3.7 meters/minute). This resulted in an adhesive thickness of about 0.002 inches (about 50 micrometers).

The adhesive composition was comprised of KRATON D 107 (a styrene-isoprene-styrene block copolymer, available from Kraton Polymers, Houston, Tex.), WINGTACK PLUS (an adhesive tackifier, available from Goodyear Chemical Company, Akron, Ohio), ATTANE (a linear low density copolymer of ethylene and octene, available from Dow Chemical Company, Midland, Mich.), and IRGANOX 1010 (an antioxidant, available from Ciba Specialty Chemicals Corporation, Tarrytown, N.Y.). In Examples 2-6 a fibrous polyolefin reinforcing material was formed from the ATTANE material during extrusion. The amount of polymeric fiber present is reported as a percentage of the entire adhesive composition including fibers. The adhesive compositions for Examples 1-6 are shown in Table 1 below.

TABLE 1

| | Wt. % | | | | |
|---|---|---|---|---|---|
| | of Poly- | Adhesive Components (parts by weight) | | | |
| Exam- | meric | KRATON | WINGTACK | ATTANE | IRGANOX |
| ple | Fibers | D1107 | PLUS | 4202 | 1010 |
| 1 | 0 | 55 | 45 | 0 | 1.1 |
| 2 | 10 | 55 | 45 | 11.2 | 1.1 |
| 3 | 15 | 55 | 45 | 17.8 | 1.1 |
| 4 | 20 | 55 | 45 | 25.3 | 1.1 |
| 5 | 25 | 55 | 45 | 33.7 | 1.1 |
| 6 | 30 | 55 | 45 | 43.3 | 1.1 |

The adhesive tapes of Examples 1-6 having a microstructured backing were evaluated for “Peel Adhesion Strength (Self-Mated)”, “Peel Adhesion Strength to Steel”, “Overlap Shear Strength to Fiberboard”, and “Rolling Ball Tack” as described in the test methods above. The results are shown in Table 2 below.

TABLE 2

| | | Peel | Peel | OLS | Rolling |
|---|---|---|---|---|---|
| | Wt. % of | Adhesion | Adhesion | (Fiber- | Ball |
| | Polymeric | (Self-mated) | (Steel) | board) | Tack |
| Example | Fibers | (N/cm) | (N/cm) | (minutes) | (mm) |
| 1 | 0 | 6.15, 13.52 | 8.68 to 10.2 | 24,915 | 3 |
| | | Avg.: 9.73 | Avg.: 9.37 | | |
| 2 | 10 | 3.17, 1.18 | 10.7 to 11.1 | 25,192 | 29 |
| | | Avg.: 2.18 | Avg.: 10.9 | | |
| 3 | 15 | 10.5, 2.48 | 10.9 to 11.2 | 21,896 | 119 |
| | | Avg.: 6.51 | Avg.: 11.1 | | |
| 4 | 20 | 3.36, 1.84 | 10.4 to 11.6 | 14,969 | 252 |
| | | Avg.: 2.60 | Avg.: 11.1 | | |
| 5 | 25 | 2.13 | 8.67 to 10.3 | 7,287 | 300+ |
| | | | Avg.: 9.31 | | |
| 6 | 30 | 1.25 | 4.11 to 6.89 | 402 | 300+ |
| | | | Avg.; 5.68 | | |

Example 1 exhibited two-bond failure: the adhesive did not stay adhered to the originally coated onto when subjected to the “Peel Adhesion Strength (Self-Mated)” test. For the same test, one sample of Example 3 also exhibited two-bond failure. The remaining examples all removed cleanly, that is, the adhesive layer stayed adhered to the backing it was originally coated onto. For the “Overlap Shear Strength to Fiberboard” test, all samples exhibited a “Pop-off” failure mode.

### Examples 7-15

The adhesive tapes of Examples 1-6 having a microstructured backing were also evaluated using the “Accelerated Flow Test” as described in the test methods above. In addition, three commercial adhesive tapes available from 3M Company, St. Paul, Minn. were also evaluated using this method. They were Example 13: 3M™ SCOTCHCAL™ Imaging Media (No. 3657-10, about 0.0025 inch (64 micrometer) thick, white opaque film having a permanent pressure sensitive adhesive thereon, available from 3M Company, St. Paul, Minn.), Example 14: 3M™ SCOTCH® Box Sealing Tape 311 (a general purpose box sealing tape having a 0.00095 inch (24 micrometer) thick pressure sensitive acrylic adhesive on a 0.0011 inch (28 micrometer) thick biaxially oriented polypropylene backing), and Example 15: 3M™ SCOTCH® Box Sealing Tape 313 (a box sealing tape having a 0.00095 inch (24 micrometer) thick pressure sensitive acrylic adhesive on a 0.0016 inch (41 micrometer) thick backing). The results are shown in Table 3 below.

TABLE 3

| | | Flow Distance (micrometers) | | | | | | | | |
|---|---|---|---|---|---|---|---|---|---|---|
| Ex. | Tape | 0.5 hr | 1 hr | 2 hrs | 3 hrs | 4 hrs | 5 hrs | 24 hrs | 48 hrs | 72 hrs |
| 7 | Example 1 | 14.8 | 18.3 | 22.5 | 22.0 | 21.8 | 22 | 21.0* | 20.0* | 22.0* |
| 8 | Example 2 | N.D. | 6.3 | 5.0 | 5.8 | 5.4 | 6.0 | 10.0 | 12.0 | 12.3 |
| 9 | Example 3 | N.D. | 4.0 | 4.8 | 5.3 | N.D. | 4.8 | 7.8 | 7.5 | 8.3 |
| 10 | Example 4 | N.D. | 4.8 | 5.5 | 5.3 | N.D. | 6.3 | 6.0 | 6.5 | 5.8 |
| 11 | Example 5 | N.D. | 5.6 | 5.8 | 5.8 | N.D. | 5.5 | 6.3 | 6.5 | 6.5 |
| 12 | Example 6 | N.D. | 4.2 | 4.5 | 4.5 | N.D. | 4.3 | 5.3 | 5.3 | 4.8 |
| 13 | SC 3650 | N.D. | 11.0 | 9.8 | 10.3 | N.D. | 11.8 | 13.0 | 11.8 | 11.8 |
| 14 | BST 311 | N.D. | N.D. | 12.0 | 11.8 | 11.5 | N.D. | 14.6 | 20.7 | 20.5 |
| 15 | BST 313 | N.D. | N.D. | 9.5 | 12.2 | 13.5 | N.D. | 15.0 | 19.3 | 20.0 |

*Tape sample had to be cooled to −76° F. (−60° C.) using dry ice to permit clean removal without adhesive transfer.

### Examples 16-20

Examples 16-20 were performed on the microstructured film used in Examples 1-6, Most of the print tests were carried out without an adhesive on the second surface of the microstructured film.

### Example 16

A sample of the microstructured film backing of the type used in Examples 1-6 and not having an adhesive layer was corona treated on the microstructured side. Corona treatment was carried out in air using an energy level of 1 Joule/cm². Two aqueous ink jet print tests were carried out on the corona-treated microstructured film without any further treatment of the film. The corona-treated microstructured film was taped to a sheet of paper using adhesive tape before loading into the ink jet printers. The microstructured side of the film was then printed.

One print test was carried out using a Hewlett-Packard HP970C ink jet printer utilizing aqueous dye-based inks and a second sample was printed using a Hewlett-Packard HP2500CP printer utilizing aqueous pigment-based inks. Both gave reasonable print quality.

### Example 17

Samples of the printable microstructured polypropylene film backing without adhesive and the adhesive tape of Example 1 were printed using phase-change (hot-melt) ink jet. Printers used included Tektronix Phaser® 340, 840 and 860 printers (available from Xerox Corporation, Stamford, Conn.) and gave excellent print quality. Samples were taped to paper using adhesive tape or adhered to paper using the sample's own adhesive layer before printing.

### Example 18

Samples of the microstructured polypropylene film backing were printed using a Sato 305 thermal transfer printer (commercially available from Sato America of Sunnyvale, Calif.) giving images legible by eye. Color density and image quality was not as good as those in Examples 16, 17, 20, and 21. Prints were carried out using three different Iimak thermal transfer ribbons; a DC-400 resin ribbon, a DC-200 hybrid resin-wax ribbon and a DC-100 wax ribbon. Iimak ribbons are available from Iimak International Imaging Materials of Amherst, N.Y.). The best optical densities were obtained with the hybrid resin. Poorer densities but better sharper images were obtained with the wax ribbon. The image with the DC-400 resin ribbon was the poorest in quality.

### Example 19

Samples of the microstructured polypropylene film backing were used as an electrophotographic print medium by passing through the sheet stock feed of Lanier Model 6720 photocopier (commercially available from Lanier Worldwide, Inc., Atlanta, Ga.) while photocopying an image. This gave a good black and white image on the microstructured side of the film.

### Example 20

A sample of the microstructured film, without adhesive, was coated on the microstructured surface with the following formulation:

| | |
|---|---|
| Aluminum sulfate octadecahydrate Al₂(SO₄)₃.18H₂O | 0.5 parts |
| Sodium dioctyl sulfosuccinate | 0.5 parts |
| Water | 74 parts |
| Isopropyl alcohol | 25 parts |

Aluminum sulfate octadecahydrate and sodium dioctyl sulfosuccinate are available from Sigma-Aldrich Corporation of St. Louis, Mo.

This was coated onto the microstructured side of the film using a wire-wrapped rod (available as a #4 Mayer Rod from R D Specialties of Webster, N.Y.) nominally depositing a wet coating thickness of 0.00036 inches (9 micrometers). Coatings were allowed to dry at room temperature overnight.

These were printed on a Hewlett-Packard DesignJet 2500CP printer loaded with pigment-based inks and gave excellent images having high optical density, good color saturation and high sharpness.

### Example 21

The microstructured film used in this example was made using FINA 3376 (a clear polypropylene resin) in a manner similar to that described for Examples 1-6, but had a slightly different microstructured pattern.

The surface comprised an array of primary microstructured elements that were about 75 micrometers deep and a microstructured element pitch of about 125 micrometers. These primary walls were about 18 micrometers wide at their top and about 36 micrometers at their bottom. The corners of the primary microstructured elements (where the walls intersect) protruded about 10 micrometers above the rest of the wall. An additional, secondary set of walls was oriented at an angle of 45 degrees to the primary walls. These secondary walls were about 10 micrometers tall, spaced with a pitch of about 35 micrometers and were nominally about 7 micrometers wide.

Prior to coating the microstructured surface with an aqueous ink jet receptor formulation, the film was corona treated. The corona treatment was carried out in air by passing a high frequency generator wand (120 volts, 50/60 Hertz, 0.35 amps, available from Electro Technic Products Inc., Chicago, Ill.) over the entire film surface at a rate of about 3 inch²/sec (19.4 cm²).

The microstructured film was coated then with the formulation described below. The following three compositions were prepared. Unless otherwise stated, all parts are parts by weight.

Composition A: 2 parts of glacial acetic acid was added to ten parts of REILLINE 420 SOLUTION (a solution of poly(4-vinylpyridine) obtained from Reilly Industries, Indianapolis, Ind.) followed by 34 parts of isopropyl alcohol then 34 parts of water. The solution was mixed after each component was added.

Composition B: 110 parts of water were added to 10 parts of “FREETEX 685” (a concentrated dye fixative containing a cationic, polyamine, available from Noveon, Inc., Cleveland, Ohio) and mixed.

Composition C: 97.5 parts of ethanol were added to 2.5 parts of “HELOXY™ MODIFIER 48” (a low viscosity aliphatic triglycidyl ether, available from Resolution Performance Products, Houston, Tex.) and mixed.

A coating composition was prepared by mixing 2.1 parts of Composition A, 0.4 parts of Composition B and 0.1 parts of Composition C. The coating composition was applied to the corona treated, microstructured surface of the film backing. The composition was applied with a #36 Mayer rod (available from R D Specialties of Webster, NY) giving a nominal wet coating thickness of 81 micrometers. The coated film was dried in a convection oven for five minutes at about 70° C. These were printed on a Hewlett-Packard DesignJet 970C utilizing dye-based inks and gave excellent print quality.

### Examples 22-27

Several different adhesives were evaluated for creep compliance and low rate viscosity using the “Steady State Shear Creep” test method described above. The following adhesives were evaluated: 22) a microfiber-containing adhesive prepared as described in Example 2 with the following modifications: the polyolefin fiber content was 8% by weight and the final adhesive thickness was 0.005 inches (127 micrometers); 23) 3M™ SCOTCH™ 300LSE High Strength Adhesive Transfer Tape (available from 3M Company, St. Paul, Minn.); 24) an acrylic copolymer composition prepared by solution polymerization of 90 pbw 2-methyl-butyl acrylate, 10 pbw acrylic acid and 0.14 pbw propylene isophthalimide to give a polymeric solution, having a intrinsic viscosity of 0.8 dL/gram as measured in ethyl acetate at 25° C., which was coated onto a release liner and dried at 70° for 15 minutes to give an adhesive transfer tape; 25) 3M™ SCOTCH™ 9485PC High Performance Adhesive Transfer Tape (available from 3M Company, St. Paul, Minn.); 26) a block copolymer-based adhesive prepared by solvent coating a composition of 20 pbw of KRATON D1107 (a styrene-isoprene-styrene block copolymer, available from Kraton Polymers, Houston, Tex.), 20 pbw of WINGTACK PLUS (an adhesive tackifier, available from Goodyear Chemical Company, Akron, Ohio), and 60 pbw toluene onto a silicone-treated paper release liner and drying at 70° for 15 minutes and 27) Example 26 hot melt coated. The results are shown in Table 4 below.

TABLE 4

| Example | Adhesive | J₀ (Pa)⁻¹ | η₀ (Pa-sec) |
|---|---|---|---|
| 22 | Microfibered Block | 4.22E−5 | 2.1E7 |
| | Copolymer Adhesive | | |
| | (Hot Melt) | | |
| 23 | 300 LSE | 6.15E−4 | 4.8E6 |
| 24 | Acrylic Adhesive | 2.41E−4 | 1.6E7 |
| 25 | 9485 PC | 5.36E−4 | 5.8E7 |
| 26 | Block Copolymer | 2.17E−4 | 2.6E6 |
| | Adhesive (Solvent) | | |
| 27 | Block Copolymer | 5.78E−4 | 1.4E7 |
| | Adhesive (Hot Melt) | | |

### Examples 28-30

Adhesive compositions were coated onto the surface of a 0.004 inch (102 micrometers) thick paper backing to provide adhesive tapes. More specifically, various adhesive compositions were extrusion coated onto the backing using a co-rotating twin screw extruder (Werner & Pfleiderer ZSK-30, available from Werner & Pfleiderer, Inc.; Ramsey, N.J.) having a diameter of about 1.18 inches (30 mm) 14 heated zones. The six zones and die temperatures were set as follows: 280° F. (138° C.), 300° F. (149° C.), 307° F. (153° C.), 312° F. (156° C.), 316° F. (158° C.), and 321° F. (161° C.) respectively. The die temperature was 325° F. (163° C.). The web speed was from about 10 to about 12 feet/minute (about 3.0 to about 3.7 meters/minute). This resulted in an adhesive thickness of about 0.001 inches (about 25 micrometers).

The adhesive composition was comprised of a styrene-isoprene-styrene block copolymer (commercially available under the tradename KRATON D1107 from Kraton Polymers, Houston, Tex.), a tackifier (commercially available under the tradename WINGTACK PLUS from Goodyear Chemical Company, Akron, Ohio), a low molecular weight polyethylene wax with a melting point of 113 C (commercially available under the tradename POLYWAX 1000 from Baker-Petrolite, Sugar Land, Tex.) and an antioxidant (commercially available under the tradename IRGANOX 1010 from Ciba Specialty Chemicals Corporation, Tarrytown, N.Y.).

The adhesive side of the tape was contacted with a microstructured film backing and evaluated as detailed in the “Accelerated Flow Test” above with the following modifications.

The microstructure on the film backing employed had a height differential between the intersection points of the walls running perpendicular to each other and a point along the wall length between the intersection points and was prepared as follows. An 83:17 (w:w) mixture of a clear polypropylene resin (Homopolymer 4018 Injection Molding Resin, available from BP Amoco Polymers, Naperville, Ill.) and a white pigmented polypropylene resin (a 1: 1 blend by weight of titanium dioxide and PP4792 μl, a polypropylene resin having a typical melt flow rate of 2.7 g/10 minutes (230° C./2.16 kg), available from ExxonMobil Chemical, Houston, Tex.) was extruded between two heated nip rollers located in close proximity to the exit die using a Davis Standard single screw extruder (available from Davis Standard Killion, Pawcatuck, Conn.). The extruder had a diameter of 6.35 cm (2.50 inches), a length/diameter ratio of 38/1, and six heated zones which were set as shown in Table 5 below. Also shown in Table 5 are the actual feedblock and die temperatures. The molten resin exited the die and was drawn between two nip rollers closed under pressure. The upper nip roll was a rubber coated roll and the lower nip roll was a metal tool roll having a microstructured pattern engraved on its surface.

The metal tool roll was engraved with three sets of grooves. There were two sets of parallel grooves, which were perpendicular to each other and are referred to hereinafter as the major grooves. These two perpendicular sets of helical grooves ran at an angle of approximately 45° to the roll axis, and had a depth of approximately 75 micrometers, a width of approximately 18 micrometers at the bottom and 31 micrometers at the top, and were spaced approximately 125 micrometers apart. The third set of grooves, hereinafter referred to as the minor grooves, ran at an angle of approximately 90° to the roll axis (i.e., parallel to the web direction) and had depth of between about 4 and about 5 micrometers, a width of approximately 8 micrometers at the bottom and approximately 11 micrometers at the top, and were spaced approximately 35 micrometers apart. The nip rolls both had a diameter of approximately 45.7 cm (18 inches) and were hollow to permit heating or chilling of the rolls by passing a fluid through their interiors. The temperatures of the upper rubber roll and lower metal, as well as the web speeds, for each example are given in Table 5 below.

The microstructured surface of the tool roll embossed the extruded polypropylene resin to provide a polypropylene film having a first major surface with a microstructured pattern thereon, and a second major surface. The embossed film cooled prior to reaching a windup roll. The embossed pattern on the film comprised wells or recesses separated by walls. The recesses were rhomboidal in shape and the walls lay at 45° to the machine direction (web direction) of the microstructured film. In addition, the bottom of the recesses contained ridges which ran at an angle of 45° to the direction of the walls of the recesses (that is, they ran parallel to the web direction) and which had a nominal height of between 8 and 10 micrometers, a width at the top of about 8 micrometers and at the bottom of about 11 micrometers, and which were spaced approximately 35 micrometers apart.

The finished microstructured backing, having a total thickness of about 0.0055 inches (140 micrometers), was inspected with a Wyco Interferrometer microscope (Model RST, obtained from Veeco Metrology Group, Tucson, Ariz.). It was observed that the walls possessed a saddle-like shape with respect to their height. There was a minimum in the wall height at a position between the intersection points and a maximum in the region of the intersection points, with the height differential being approximately 13 micrometers. The ridges in the bottom of the recesses exhibited a uniform height.

In measuring the degree of adhesive flow, a dwell time of 72 hours was used, and the first measurement was taken at a point in the adhesive corresponding to where it was in contact with the intersection points of the walls of microstructure.

The formulations and results are shown in Tables 6 and 7 below.

TABLE 5

| Parameters | Settings |
|---|---|
| Feedblock | 227 |
| ° C. (° F.) | (440) |
| Zone 1 | 158 |
| ° C. (° F.) | (316) |
| Zone 2 | 193 |
| ° C. (° F.) | (380) |
| Zone 3 | 204 |
| ° C. (° F.) | (400) |
| Zone 4 | 216 |
| ° C. (° F.) | (420) |
| Zone 5 | 227 |
| ° C. (° F.) | (440) |
| Zone 6 | 227 |
| ° C. (° F.) | (440) |
| Die | 227 |
| ° C. (° F.) | (440) |
| Rubber Roll | 54 |
| ° C. (° F.) | (130) |
| Tool Roll | 57 |
| ° C. (° F.) | (135) |
| Web Speed | 22.9 |
| meters/minute | (75.0) |
| (feet/minute) | |

TABLE 6

| | pbw | | pbw | |
|---|---|---|---|---|
| | SIS Block | pbw | CRYSTALLINE | pbw |
| Exam- | Copolymer | Tackifier | WAX | antioxidant |
| ple | (type) | (type) | (type) | (type) |
| 28 | 100 | 80 | 100 | 1 |
| | (KRATON | (WINGTACK | (POLYWAX | (IRGANOX |
| | D1107) | PLUS) | 1000) | 1010) |
| 29 | 100 | 60 | 80 | 1 |
| | (KRATON | (WINGTACK | (POLYWAX | (IRGANOX |
| | D1107) | PLUS) | 1000) | 1010) |
| 30 | 100 | 40 | 60 | 1 |
| | (KRATON | (WINGTACK | (POLYWAX | (IRGANOX |
| | D1107) | PLUS) | 1000) | 1010) |

| | | Activation | |
|---|---|---|---|
| | pbw | Temp. | Flow Distance |
| Ex. | Wax | (° C.) | (micrometers) |
| 28 | 100 | 100 | 0 |
| 29 | 80 | 100 | 0 |
| 30 | 60 | 100 | 0 |

### Examples 31-33

Examples 28-30 were repeated with the following modifications. A styrene-isoprene-styrene block copolymer (commercially available under the tradename KRATON D1114 from Kraton Polymers, Houston, Tex.) was used in place of KRATON D1107 copolymer; a tackifier (commercially available under the tradename ESCOREZ 1310 available from EXXON-MOBIL, Houston, Tex.) was used in placed of WINGTACK PLUS tackifier; and 0.003 inch (76 micrometers) thick polypropylene film was used in place of the paper backing. The formulations are summarized in Table 8 below. These were evaluated as described in Examples 28-30 and the results in Table 9 below.

| | pbw | | pbw | |
|---|---|---|---|---|
| | SIS Block | pbw | CRYSTALLINE | pbw |
| | Copolymer | Tackifier | WAX | antioxidant |
| Example | (type) | (type) | (type) | (type) |
| 31 | 100 | 100 | 75 | 1 |
| | (KRATON | (ESCOREZ | (POLYWAX | (IRGANOX |
| | D1114) | 1310) | 1000) | 1010) |
| 32 | 100 | 100 | 50 | 1 |
| | (KRATON | (ESCOREZ | (POLYWAX | (IRGANOX |
| | D1114) | 1310) | 1000) | 1010) |
| 33 | 100 | 100 | 30 | 1 |
| | (KRATON | (ESCOREZ | (POLYWAX | (IRGANOX |
| | D1114) | 1310) | 1000) | 1010) |

TABLE 9

| | | Activation | |
|---|---|---|---|
| | pbw | Temperature | Flow Distance |
| Ex. | Wax | (° C.) | (micrometers) |
| 31 | 75 | 90 | 0 |
| 32 | 50 | 90 | 0 |
| 33 | 30 | 90 | 0 |

### Examples 34-39

An acrylic adhesive composition was prepared and evaluated for accelerated flow. An acrylic copolymer composition of 48 pbw 2-ethylhexyl acrylate, 50 pbw behenyl acrylate (available from Cognis, Ambler, Pa.), and 2 pbw acrylic acid was prepared by solution polymerization at 40% solids in ethylacetate to give a polymeric solution having a intrinsic viscosity of 0.8 dugram, as measured in ethyl acetate at 25° C. Just prior to coating, the polymer solution was diluted with toluene to give a 30% solids solution and mixed with a chemical crosslinker (propylene-bis-isophthalimide) at the levels indicated in the table below. The crosslinker charges and adhesive amounts were based on the solids level. The thoroughly mixed solution was coated on a 0.0015 inch (37.5 micrometers) thick polyester backing and oven dried at 70° C. for 15 minutes. The coated backing was allowed to cool to room temperature, placed on a board with the exposed adhesive layer open to the air, and stored overnight at room temperature. The tape was then evaluated as described in Examples 28-30 above. The results are shown in Table 10 below.

TABLE 10

| | Activation | % | Flow Distance |
|---|---|---|---|
| Ex. | Temp. (° C.) | Crossslinker | (micrometers) |
| 34 | 40 | 0 | * |
| 35 | 40 | 0.5 | 13 |
| 36 | 40-50 | 1 | 7 |
| 37 | 80+ | 2 | 8 |
| 38 | 80+ | 3 | 2 |
| 39 | 80+ | 5 | 2 |

*could not remove cleanly

Various modifications and alterations of the present invention will become apparent to those skilled in the art without departing from the spirit and scope of the invention.

What is claimed is:

1. An article comprising
a backing, the backing comprising a first major surface and a second major surface, wherein the first major surface comprises a microstructured surface comprising microstructure elements; and
a low-flow adhesive layer opposite the microstructured surface

2. The article of claim 1 wherein the low-flow adhesive layer is on the second major surface of the backing.

3. The article of claim 2 further comprising a second adhesive layer on the low-flow adhesive layer opposite the backing.

4. The article of claim 1 further comprising at least one adhesive layer between the low-flow adhesive layer an the backing.

5. The article of claim 1 wherein the microstructured surface defines depressed microstructure elements and the depressed microstructure element has a surface.

6. The article of claim 1 wherein the microstructured surface comprises protruding microstructure elements.

7. The article of claim 1 wherein the microstructured surface defines depressed microstructure elements and protruding microstructure elements.

8. The article of claim 1 wherein the microstructured elements are randomly placed on the microstructured surface.

9. The article of claim 1 wherein the microstructured elements are regularly placed on the microstructured surface.

10. The article of claim 1 comprising an ink receptor on the microstructured surface.

11. The article of claim 1 comprising an ink on the microstructured surface.

12. The article of claim 5 comprising an ink receptor on the microstructured element surface.

13. The article of claim 12 wherein the ink receptor is a copolymer of polyvinyl pyridine.

14. The article of claim 5 comprising an ink on the microstructured element surface.

15. The article of claim 14 wherein the ink is a water based ink.

16. The article of claim 14 wherein the ink is a solvent based ink.

17. The article of claim 14 wherein the ink is a solid ink.

18. The article of claim 1 wherein the low-flow adhesive is a heat activatable adhesive.

19. The article of claim 1 wherein the low-flow adhesive is a pressure sensitive adhesive.

20. The article of claim 19 wherein the pressure sensitive adhesive comprises a reinforcing material.

21. The article of claim 20 wherein the reinforcement material is a substantially continuous fiber.

22. The article of claim 20 wherein the reinforcement material is a woven fabric.

23. The article of claim 1 wherein a release layer is on the microstructured surface.

24. The article of claim 1 wherein the backing comprises a release material.

25. The article of claim 1 wherein the microstructured elements have a cubic structure.

26. The article of claim 1 wherein the low-flow adhesive flows less than 8 micrometers after 24 hours at 70° C. as tested according to the Accelerated Adhesive Flow Test.

27. An article comprising
a backing comprising a first major surface and a second major surface, wherein the first major surface comprises a microstructured surface comprising microstructured elements; and
a pressure sensitive adhesive layer opposite the microstructured surface, wherein the pressure sensitive adhesive comprises a pressure sensitive adhesive matrix and a fibrous reinforcing material within the pressure sensitive adhesive matrix.

28. The article of claim 27 wherein the fibrous reinforcing material is substantially continuous fibers.

29. The article of claim 27 wherein the pressure sensitive adhesive matrix is a styrene-isoprene-styrene block copolymer matrix.

30. The article of claim 27 wherein the fibrous reinforcing material is an olefin polymer.

31. A multi-layer article comprising
a first layer comprising
a first backing, the backing comprising a first major surface and a second major surface, wherein the first major surface comprises a microstructured surface comprising microstructured elements; and
a first low-flow adhesive layer on the second major surface of the first backing; and
a second layer comprising
a second backing, the backing comprising a first major surface and a second major surface, wherein the first major surface comprises a microstructured surface comprising microstructured elements; and
a second low-flow adhesive layer on the second major surface of the second backing,
wherein the first adhesive layer is in contact with the first major surface of the second backing.

32. The multi-layer article of claim 31 wherein the peel adhesion is no greater than 9.5 N/cm.

33. A multi-layer article comprising
a first layer comprising
a first backing, the backing comprising a first major surface and a second major surface, wherein the first major surface comprises a microstructured surface comprising microstructured elements; and
a first adhesive layer on the second major surface of the first backing; and
a second layer comprising
a second backing, the backing comprising a first major surface and a second major surface, wherein the first major surface comprises a microstructured surface comprising microstructured elements; and
a second adhesive layer on the second major surface of the second backing,
wherein the first adhesive layer is in contact with the first major surface of the second backing and the peel adhesion is no greater than 9.5 N/cm.

34. An article comprising
a backing, the backing comprising a first major surface and a second major surface, wherein the first major surface comprises a microstructured surface comprising microstructured elements; and
an adhesive layer opposite the microstructured surface, wherein the peel adhesion is no greater than 9.5 N/cm.

35. An article comprising
a backing, the backing comprising a first major surface and a second major surface, wherein the first major surface comprises a microstructured surface comprising microstructure elements; and
an adhesive layer opposite the microstructured surface, wherein the adhesive has a creep compliance of less than 7×10⁻⁴ Pa⁻¹ and a viscosity greater than 1×10⁶ Pa·s.

36. A multi-layer article comprising
a first layer comprising
a first backing, the backing comprising a first major surface and a second major surface, wherein the first major surface comprises a microstructured surface comprising microstructured elements; and
a first adhesive layer on the second major surface of the first backing, wherein the adhesive has a creep compliance of less than 7×10⁻⁴ Pa⁻¹ and a viscosity greater than 1×10⁶Pa·s; and
a second layer comprising
a second backing, the backing comprising a first major surface and a second major surface, wherein the first major surface comprises a microstructured surface comprising microstructured elements; and
a second adhesive layer on the second major surface of the second backing, wherein the adhesive has a creep compliance of less than 7×10⁻⁴ Pa⁻¹ and a viscosity greater than 1×10⁶ Pa·s and wherein the first adhesive layer is in contact with the first major surface of the second backing.

37. An article comprising
a backing, the backing comprising a first major surface and a second major surface, wherein the first major surface comprises a microstructured surface comprising microstructure elements; and
a heat activatable adhesive layer opposite the microstructured surface.
